(19) United States
(12) Patent Application Publication
(10) Pub. No.: US 2014/0122036 A1
(43) Pub. Date: May 1, 2014

(54) METHODS AND SYSTEMS FOR ANALYZING THE EFFECT OF FLUID SOLID INTERACTIONS AND PULSATION ON TRANSPORT OF LOW-DENSITY LIPOPROTEIN THROUGH AN ARTERIAL WALL

(71) Applicant: Kambix Innovations, LLC, Albuquerque, NM (US)

(72) Inventors: Kambiz Vafai, Mission Viejo, CA (US); Stephen Chung, Westminster, CA (US)

(73) Assignee: Kambix Innovations, LLC, Albuquerque, NM (US)

(21) Appl. No.: 14/048,423

(22) Filed: Oct. 8, 2013

Related U.S. Application Data
(60) Provisional application No. 61/718,817, filed on Oct. 26, 2012.

(51) Int. Cl. G06F 19/12

(52) U.S. Cl. CPC G06F 19/12
USPC 703/2

(57) ABSTRACT

Methods and systems for analyzing the effects of Fluid Solid Interactions (FSI) and pulsation on the transport of Low-Density Lipoprotein (LDL) through an elastic wall (e.g., an arterial wall). A comprehensive multi-layer model for both LDL transport as well as FSI can be analyzed and compared with existing results in limiting cases. The model takes into account the complete multi-layered LDL transport while incorporating FSI aspects to enable a comprehensive study of the deformation effect on the pertinent parameters of the transport processes within an artery. Since the flow inside an artery is time-dependent, the impact of pulsatile flow is also analyzed with and without FSI. The consequence of different factors on LDL transport in an artery is also analyzed.

### CROSS-REFERENCE TO PROVISIONAL PATENT APPLICATION

This patent application claims the benefit under 35 U.S.C. §119(e) of U.S. Provisional Application Ser. No. 61/718,817 entitled, “Effect of the Fluid-Structure Interactions on Low-Density Lipoprotein Transport within a Multi-Layered Arterial Wall,” which was filed on Oct. 26, 2012 and is incorporated herein by reference in its entirety.

### FIELD OF THE INVENTION

Embodiments are generally related to the transport of LDL (Low-Density Lipoprotein) through arterial walls. Embodiments also relate to the analysis of the effects of Fluid Solid Interactions (FSI) and pulsation on the transport of LDL through arterial walls.

### BACKGROUND

Atherosclerosis and cardiovascular diseases have been studied by many researchers due to their broad impact on the longevity and mortality of the population at large. The existence of higher concentrations of macromolecules, mainly LDL, is an important factor in the initiation of atherosclerosis. To understand and assess the impact of LDL transport on atherosclerosis, a comprehensive model, which is capable of displaying the transport phenomena within different layers of the arterial wall, is required.

One of the earlier models for transport inside a blood vessel was presented by Prosi at al. (2005), which introduced two primary models—wall-free and lumen-wall models. These models are widely used to study mass transfer within arteries (Rappitsch and Perktold, 1996; Wada and Karino, 2000; Moore and Ethier, 1997; Stangeby and Ethier, 2002a, b). It is more appropriate to treat the arterial wall as non-homogenous, since each of the layers posses a different structure. For example, endothelium, a thin layer between intima and lumen, has a role in reducing disturbances in the blood flow, while adventitia is a thicker gel layer that attaches to organs to stabilize the artery's position. In general, the hydraulic, mass transport, and elastic properties for these different layers are different. As such a multi-layer model is much more realistic. Several aspects related to the macro-scale (Huang et al., 1994; Tada and Tarbell, 2004) as well as micro-scale (Fry, 1985; Karner et al., 2001; F. Yuan et al., 1991; Weinbaum et al., 1992; Wen et al., 1988) features should be incorporated within a single model.

To describe the mass transfer inside a low permeability porous media, traditional Staverman-Kedem-Katchalsky membrane equation (Kedem and Katchalsky 1958) is usually invoked. Built on a steady state assumption, the equation might not be appropriate for a time dependent process such as when the effect of pulsation is taken into account. Yang and Vafai (2006, 2008) and Ai and Vafai (2006) had developed a comprehensive new four-layer model, where endothelium, intima, Internal Elastic Lamina (IEL), and media are all treated as different layers macroscopically. Porous media approach has been utilized based on volume averaging theorems to establish the governing equations while accounting for the Staverman filtration and osmosis effects.

In Yang and Vafai (2006, 2008) and Ai and Vafai's (2006) works, details of the interactions between lumen and arterial wall are analyzed, and Staverman filtration and osmotic reflection are incorporated in their model to account for selective permeability. The development of homogeneous properties in each of the layers was discussed and obtained based on microscopic structure of different membranes (Huang et al., 1992; Huang et al., 1997; Huang and Tarbell, 1997; Karner et al., 2001) or the available experimental data utilizing a circuit analogy model (Prosi et al. 2005; Ai and Vafai, 2006). The effect of adventitia was embedded within the flux (or concentration) condition located at the outer boundary of media. Glycocalyx, a very thin layer that covers and separates endothelium from lumen region was found to be negligible (Michel and Curry, 1999; Tarbell, 2003).

Most of the earlier works treat the arterial wall as a solid non-elastic medium, which does not represent the real physiological condition. The arterial wall is an elastic bio-material, which will deform due to the pressure difference across the arterial wall. Furthermore, this deformation changes in time since the pressure applied from lumen side is affected by the pulsation of cardiovascular system. Gao et al, (2006a,b) performed a numerical simulation on the stress distribution across the aorta wall. Based on the work of Gao et al. (2006a, b), which considers zero pressure at the outlet of aorta, Khanafer and Berguer (2009) introduced a more realistic model by applying time-dependent pressure in a wave-form. Utilizing the Fluid-Structure Interaction (FSI) model, Khanafer et al. (2009) further analyzed the turbulent flow effect and the wall stress on aortic aneurysm.

Therefore, a need exists for improved system and method that couples the multi-layer model for LDL transport while fully incorporating the FSI effects.

### SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide a technique for analyzing the transport of LDL through an arterial wall.

It is another aspect of the disclosed embodiments to provide method and system for analyzing effects of Fluid Solid Interactions (FSI) and pulsation on the transport of Low-Density Lipoprotein (LDL) through arterial walls.

It is a further aspect of the disclosed embodiments to analyze the change of hydraulic and mass transfer properties due to wall deformation and investigate its effect on flow and LDL transport through the arterial wall.

The aforementioned aspects and other objectives and advantages can now be achieved as described herein. Methods and systems for analyzing the effects of Fluid Solid Interactions (FSI) and pulsation on the transport of Low-Density Lipoprotein (LDL) through an arterial wall are disclosed. A comprehensive multi-layer model for both LDL transport as well as FSI is introduced. The constructed model can be analyzed and compared with existing results in limiting cases. Excellent agreement was found between the presented model and the existing results in the limiting cases. The presented model takes into account the complete multi-layered LDL transport while incorporating the FSI aspects to enable a comprehensive study of the deformation effect on the pertinent parameters of the transport processes within an artery. Since the flow inside an artery is time-dependent, the impact of pulsatile flow is also analyzed with and without FSI. The consequence of different factors on the LDL transport in an artery is also analyzed.

It is to be understood that both the foregoing general description and the following detailed description are exemplary and explanatory only and are intended to provide further explanation of the invention as claimed. The accompanying drawings are included to provide a further understanding of the invention and are incorporated in and constitute part of this specification, illustrate several embodiments of the invention, and together with the description serve to explain the principles of the invention.

### BRIEF DESCRIPTION OF THE FIGURES

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1A illustrates a structure of the wall for an artery, in accordance with the disclosed embodiments;

FIGS. 1B-1C illustrate a structure of the junction of the artery wall depicted in FIG. 1A, in accordance with the disclosed embodiments;

FIG. 2 illustrates a structure of the computation domain of the artery wall depicted in FIG. 1A, in accordance with the disclosed embodiments;

FIGS. 3A-3B illustrate graphs showing comparison of filtration velocity of Yang and Vafai (2006) and the disclosed embodiments, respectively;

FIGS. 3C-3D illustrate graphs showing comparison of LDL concentration at lumen-endothelium interface of Yang and Vafai (2006) and the disclosed embodiments, respectively;

FIGS. 4A-4B illustrate graphs showing comparison of normalized LDL concentration across intima, IEL, and media at different gage pressures and effective diffusivities with numerical results of Yang and Vafai (2006) and the disclosed embodiments, respectively;

FIGS. 4C-4D illustrate graphs showing comparison of normalized LDL concentration across intima, IEL, and media at different gage pressures and effective diffusivities with analytical results of Yang and Vafai (2008) and the disclosed embodiments, respectively;

FIGS. 5A-5B illustrate graphs showing comparison of normalized LDL concentration across intima, IEL, and media at different gage pressures and effective diffusivities with numerical and analytical results of Yang and Vafai (2006, 2008) and the disclosed embodiments, respectively;

FIGS. 6A-6B illustrate graphs showing comparison of filtration velocity at different interface and axial locations of Ai and Vafai (2008) and the disclosed embodiments, respectively;

FIGS. 7A-7B illustrate graphs showing comparison of normalized LDL concentration at lumen-endothelium interface of Ai and Vafai (2008) and the disclosed embodiments, respectively;

FIGS. 7C-7D illustrate graphs showing comparison of normalized LDL concentration at other interface of Ai and Vafai (2008) and the disclosed embodiments, respectively;

FIGS. 8A-8D illustrate graphs showing comparison of normalized LDL concentration across endothelium, intima, IEL and media respectively of Ai and Vafai (2006) with one or more of the disclosed embodiments;

FIGS. 9A-9B illustrate graphs showing comparison of Von Mises Stress across arterial wall at different steps in pulsation cycle of Khanafer and Berguer (2009) and the disclosed embodiments, respectively;

FIGS. 10A-10B illustrate graphs showing Von Mises Stress across media at different steps in pulsation cycle and different modulus of elasticity with those by Khanafer and Berguer (2009) and the disclosed embodiments;

FIG. 11 illustrates a graph showing half width of leaky junction (w) variations with the angular strain ε, in accordance with the disclosed embodiments;

FIGS. 12A-12D illustrate graphs showing permeability K_{end}, effective diffusivity D_{eff}, reflection coefficient σ_{end} and sieving coefficient γ_{end}(=1−σ_{end}), variations with angular strain ε at different φ and βᵢⱼ of endothelium, respectively;

FIG. 13 illustrates a graph showing Von Misses stress variations at the lumen-endothelium interface for different pressure drops across the arterial wall and different FSI models, in accordance with the disclosed embodiments;

FIG. 14 illustrates a graph showing angular strain ε variations at the lumen-endothelium interface for different pressure drops across the arterial wall and different FSI models, in accordance with the disclosed embodiments;

FIGS. 15A-15D illustrate graphs showing filtration velocity variations at the lumen-endothelium interface and normalized LDL concentration across endothelium, intima and IEL, and media, for different β and Δp, respectively;

FIGS. 16A-16D illustrate graphs showing filtration velocity variations at the lumen-endothelium interface and normalized LDL concentration across endothelium, intima and IEL, and media, for different φ and Δp, respectively;

FIGS. 17A-17B illustrate graphs showing filtration velocity and normalized LDL concentration respectively at different pulsation periods, in accordance with the disclosed embodiments;

FIG. 18 illustrates a graph showing effect of FSI on filtration velocity incorporating the pulsation at the mid axial position of the endothelium layer, in accordance with the disclosed embodiments; and

FIGS. 19A-19B illustrate graphs showing effect of FSI on normalized LDL concentration incorporating the pulsation at the mid axial position of the lumen-endothelium interface and mid axial position of the endothelium-intima interface respectively.

### DETAILED DESCRIPTION

The particular values and configurations discussed in these non-limiting examples can be varied and are cited merely to illustrate at least one embodiment and are not intended to limit the scope thereof.

The following Table 1 provides the various symbols and meanings used in this section:

TABLE 1

| | |
|---|---|
| c | LDL concentration |
| \ddot{d}ₛ | acceleration within the solid region |
| D | LDL diffusivity |
| fₛ | solid domain body force |
| H | thickness of the layers |
| k | reaction coefficient |
| K | permeability |
| L | length of the artery |
| L_{end} | thickness of the endothelium layer |
| N″ | solute mass flux per area |
| p | hydraulic pressure |
| Δp | pressure drop across arterial wall |
| Δp* | time-dependent pressure drop across arterial wall |
| Pe | Peclet number |
| rₘ | molecular radius |
| R_{cell} | radius of endothelial cell |
| R | radius of lumen domain |
| t | time |
| T | pulsation period |
| u | axial velocity |
| ū | velocity vector |
| U | maximum velocity at entrance |
| U* | time-dependent maximum velocity at entrance |
| v | filtration velocity |
| w | half width of the leaky junction |
| dₗⱼ | rₘ/w |
| β | ratio of the pore deformation to the wall deformation |
| γ | sieving coefficient (1-σ) |
| δ | porosity |
| ε | angular strain |
| φ | fraction of cells with leaky junction |
| μ | viscosity |
| ρ | fluid density |
| ρₛ | membrane density |
| σₛ | Cauchy stress tensor |
| σ | reflection coefficient |

Subscripts

| | |
|---|---|
| 70 mmHG | refers to properties with a gage pressure of 70 mmHg |
| eff | refers to effective property |
| end | refers to endothelium layer |
| lj | refers to leaky junction |
| nj | refers to normal junction |

The following Table 2 provides parameters used in the numerical simulations of Yang and Vafai 2006, 2008; Khanafer and Berguer, 2009. “*” indicates the parameters with gage pressure of 70 mmHg and adjusted based on deformation of endothelium for different gage pressures.

TABLE 2

| | Lumen | endothelium | intima | IEL | media | adventitia |
|---|---|---|---|---|---|---|
| density | 1.07 × 10³ | 1.057 × 10³ | 1.057 × 1 [symbol] | 1.057 × 10³ | 1.057 × 10³ | 1.057 × 10³ |
| ρ [kg/mm³] | | | | | | |
| diffusivity | 2.87 × 10⁻¹¹ | 5.7061 × 10⁻¹⁸* | 5.4 × 10⁻¹ [symbol] | 3.18 × 10⁻¹⁵ | 5 × 10⁻¹⁴ | |
| D_{eff} [m²/s] | | | | | | |
| elasticity | | 2 | 2 | 2 | 6 | 4 |
| [MPa] | | | | | | |
| permeability | | 3.22 × 10⁻²¹* | 2 × 10⁻¹⁶ | 4.392 × 10⁻¹⁹ | 2 × 10⁻¹⁸ | |
| K [m²] | | | | | | |
| porosity δ | | 5 × 10⁻⁴ | 0.983 | 0.002 | 0.258 | |
| reaction | 0 | 0 | 0 | 0 | 3.197 × 10⁻⁴ | |
| coefficient | | | | | | |
| k [s⁻¹] | | | | | | |
| refection | | 0.9888* | 0.8272 | 0.9827 | 0.8836 | |
| coefficient σ | | | | | | |
| thickness | 3100 | 2 | 10 | 2 | 200 | 100 |
| H [μm] | | | | | | |
| Viscosity | 3.7 × 10⁻³ | 0.72 × 10⁻³ | 0.72 × 10 [symbol] | 0.72 × 10⁻³ | 0.72 × 10⁻³ | |
| μ_{eff} | | | | | | |
| [kg/m · s] | | | | | | |

[symbol]

indicates data missing or illegible when filed

### 1. FORMULATION

### 1.1 Multi-Layer Model

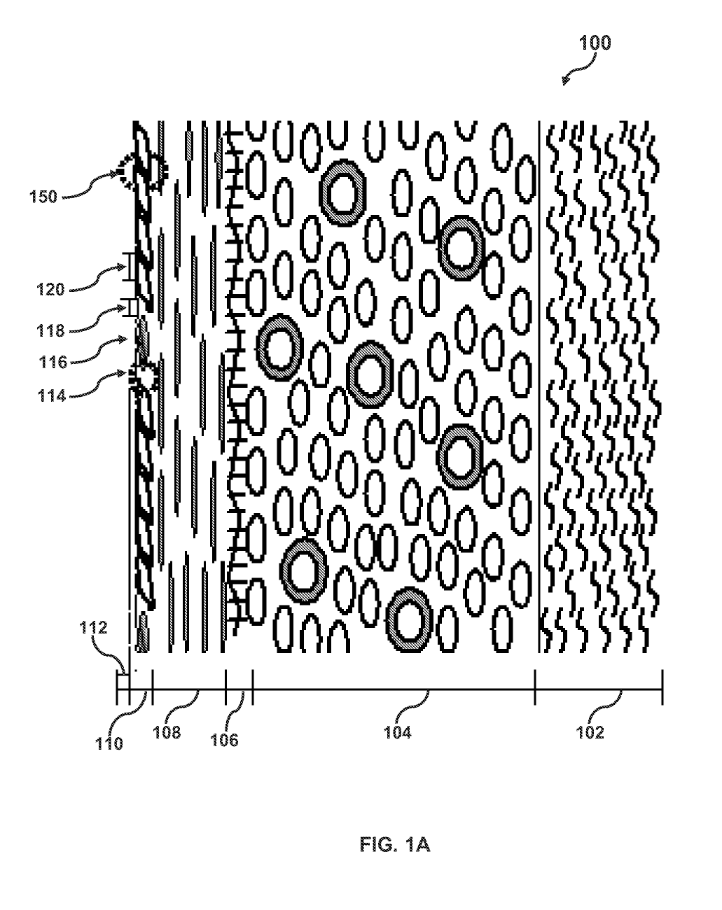

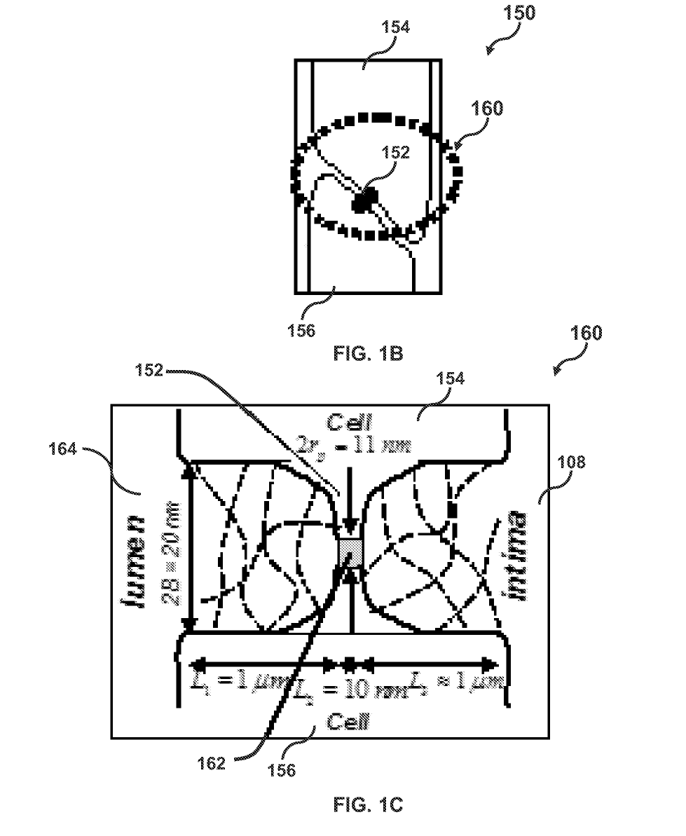

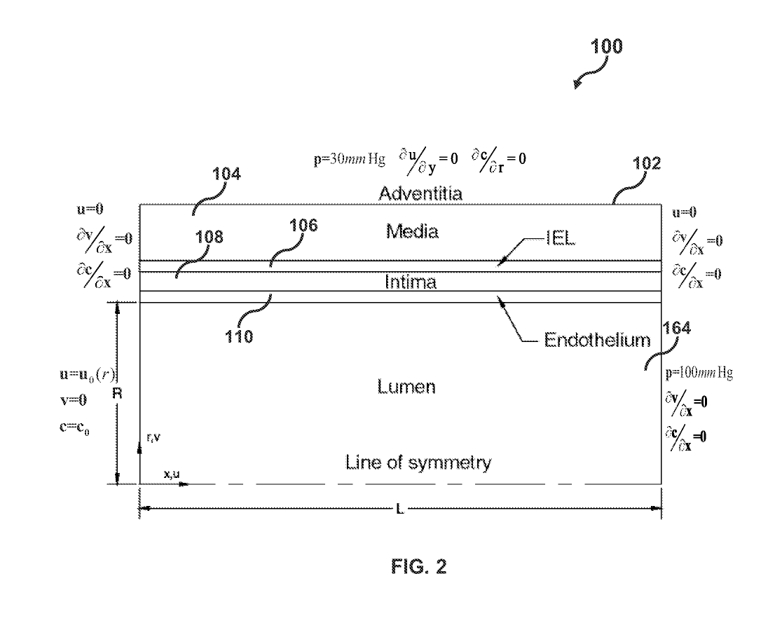

A typical structure of an artery wall 100 can be represented by six layers as shown in FIG. 1A and FIG. 2. These layers are moving away from the lumen 164, glycocalyx 112, endothelium 110, intima 108, Internal Elastic Lamina (IEL) 106, media 104, and adventitia 102. As mentioned earlier, glycocalyx 112 will not be considered due to its negligible thickness (Yang and Vafai, 2006, 2008; Ai and Vafai, 2006). The endothelium 110 is a thin layer attached at the inner side of the artery, which protects the arterial wall 100 from the inner side and reduces the blood flow disturbances. Next, intima 108 allows flexibility within the arterial wall 100, while the internal elastic lamina 106 is a thin low-permeability layer connecting intima 108 and media 104. Media 104 is a layer with capillaries passing through it and surrounded by adventitia 102, a gel-like layer which stabilizes the artery by connecting it to an adjacent organ.

The lumen 164 domain is considered as a cylindrical geometry with radius of R and axial length L. Surrounding the lumen 164, the thickness and properties of each layer of arterial wall 100 is shown in Table 2, where the data for endothelium 110, intima 108, IEL 106, and media 104 (Prosi et al., 2005; Karner et al., 2001) is utilized (Yang and Vafai, 2006, 2008; Ai and Vafai, 2006).

FIGS. 1B-1C illustrate a structure of the junction 150 of the artery wall 100 depicted in FIG. 1A, in accordance with the disclosed embodiments. The reference numeral 160 depicted in FIG. 1C represents the expanded view of the junction 150 depicted in FIG. 1B. Normal junction 162, cells 154 and 156 and strands 152 are shown in FIGS. 1B and 1C.

### 1.2 Governing Equations

In the lumen part, the flow can be described by Navier-Stokes equation. The governing equations for conservation of mass, momentum, and species are:

$$∇ \cdot \vec{u} = 0 \\ ρ \frac{D \vec{u}}{Dt} = - ∇ p + μ {∇}^{2} \vec{u} \\ \frac{\partial c}{\partial t} + \vec{u} \cdot ∇ c = D {∇}^{2} c \qquad Eq . ( 1 )$$

where \vec{u} is the velocity vector, c LDL concentration, p hydraulic pressure, and ρ, μ, and D are the fluid density, viscosity, and diffusivity coefficient respectively.

The hydraulic and mass transfer characteristics of adventitia 102 can be represented by a boundary condition at its outer layer (Yang and Vafai, 2006, 2008; Ai and Vafai's, 2006). The flow and mass transfer governing equations within the four layers: endothelium 110, intima 108, IEL 106, and media 104 can be represented by

$$∇ \cdot \vec{u} = 0 \\ \frac{ρ}{δ} \frac{\partial \vec{u}}{\partial t} + \frac{{μ}_{eff}}{K} \vec{u} = - ∇ p + {μ}_{eff} {∇}^{2} \vec{u} \\ \frac{\partial c}{\partial t} + ( 1 - σ ) \vec{u} \cdot ∇ c = {D}_{eff} {∇}^{2} c - kc \qquad Eq . ( 2 )$$

where δ is the porosity; μ_{eff} effective fluid viscosity, K permeability; σ reflection coefficient; D_{eff} effective LDL diffusivity, k reaction coefficient that is non-zero only inside the media layer, and is zero for the other layers (Prosi et al., 2005; Yang and Vafai, 2006, 2008). The properties for each of the layers are listed in Table 2, where the endothelium 110 properties change with deformation.

A hyper-elastic model is used to describe the elastic structure (e.g., elastic wall) of the artery. The elastodynamic equation can be written as:

ρₛ\ddot{d}ₛ=∇σₛ+fₛ Eq. (3)

where ρₛρₛ is the density, \ddot{d}ₛ acceleration within the solid region, fₛ solid domain body force and σₛ is the Cauchy stress tensor, where Mooney-Rivlin material model is invoked to describe the strain-energy relationship.

### 1.3 Boundary Conditions

The boundary conditions are shown in FIG. 2, where the entrance velocity is expressed as:

u=U*(1−(r/R)²)at x=0,0≦r≦R Eq. (4a)

where U*=U(1+sin(2πt/T)) and the pressure drop across the lumen and the arterial wall is expressed as:

Δp*=Δp+25 sin(2πt/T) Eq. (4b)

The nominal maximum entrance velocity and pressure drop through the arterial wall, U and Δp, are taken as 0.338 m/s and 70 mm Hg for the steady state case. For a pulsatile flow with a time period of, for example, T=1 s, U*, and Δp* dependency on time can be presented as 0.338(1+sin(2πt/T))[m/s] and 70+25 sin(2πt/T) [mmHg], respectively. Note that although reference is made herein to pulsatile (short term pressure change with period ˜1 s), we also examine the effect on hypertension (long term pressure with longer period). In any event, LDL concentration at the entrance can be taken as c₀=28.6×10⁻³ mol/m³. Jump conditions for momentum, mass transfer, and the elastic structure are invoked at the interface between each of the layers. The Staverman filtration is invoked when representing the continuity of LDL transport as:

$$[ ( 1 - σ ) uc - D \frac{\partial c}{\partial r} ] {\vert}_{+} = [ ( 1 - σ ) uc - D \frac{\partial c}{\partial r} ] {\vert}_{-} \qquad Eq . ( 5 )$$

1.4 Calculation of Endothelium Properties from the Micro-Structure Attributes

Endothelium 110 is a layer that causes the highest hydraulic and mass transfer resistance across the wall 100 of an artery due to its small pore size. Therefore, the elastic deformation in the arterial wall will have much more impact on flow and mass transfer behavior within the endothelium layer 110. The pores of endothelium 110 can be characterized as normal or leaky junction 114 as shown in FIG. 1A. Normal junction 162 is the space between strands 152 which connects the endothelial cells 150 and 160. Leaky junction 114 is formed due to dysfunctional strands 152 when the cells 150 and 160 are damaged resulting in altered strands with a cross-sectional area which is substantially larger than the normal junction. The reference numeral 116 represents damaged cell and reference numerals 120 and 118 represent R_{cell} and 2_{w}, respectively, where R_{cell} is the radius of the endothelial cell taken as 15 μm and 2_{w} is the width of the leaky junction 114 respectively.

Pore theorem is well accepted for calculating permeability, effective diffusivity, and reflection coefficient in the literature (Curry, 1984; Huang et al., 1992; Karner et al., 2001). Applying pore theorem, the endothelium permeability K_{end} can be expressed as:

$$\begin{matrix}{K}_{end} = {K}_{lj} + {K}_{nj} & Eq . ( 6 a ) \\ {K}_{lj} = \frac{{w}^{2}}{3} \frac{4 w φ}{{R}_{Cell}} & Eq . ( 6 b )\end{matrix}$$

where w is the half-width of the leaky junction, R_{cell} is radius of the endothelial cell taken as 15 μm, and φ is the fraction of the leaky junction taken as 5×10⁻⁴ (Huang et al., 1992).

In this study, the normal junction is assumed to be impermeable for the LDL molecule (Dₙⱼ=0; σₙⱼ=1) since the average radius of the normal junction is 5.5 nm, which is smaller the radius of LDL molecule (rₘ=11 nm). Therefore, using the pore theorem and incorporating the effect of the tissue matrix, the effective diffusivity and reflection coefficients can be calculated as:

$$\begin{matrix}\begin{matrix}{D}_{end} = {D}_{lj} \\ = {D}_{free} ( 1 - {α}_{lj} ) ( 1 - 1.004 {α}_{lj} + 0.418 {α}_{lj}^{3} - 0.169 {α}_{lj}^{5} ) \frac{4 w}{{R}_{cell}} φ\end{matrix} & Eq . ( 7 ) \\ {σ}_{end} = \frac{{σ}_{nj} {K}_{nj} + {σ}_{lj} {K}_{lj}}{{K}_{nj} + {K}_{lj}} = 1 - \frac{( 1 - {σ}_{lj} ) {K}_{lj}}{{K}_{nj} + {K}_{lj}} & Eq . ( 8 a ) \\ {σ}_{lj} = 1 - ( 1 - \frac{3}{2} {α}_{lj}^{2} + \frac{1}{2} {α}_{lj}^{3} ) ( 1 - \frac{1}{3} {α}_{lj}^{2} ) & Eq . ( 8 b )\end{matrix}$$

where αᵢⱼ is the ratio of rₘ to w.

Huang et al. (1992) and Karner et al., (2001) specified the half width of the leaky junction as w=10 nm, which is the same as the cleft opening for a normal junction. This value of width is smaller than the radius of LDL particle, so leaky junction, by pore theorem, becomes impermeable to LDL molecule. However, when deformation occurs, realistically, without the connection of strands between cells, leaky junction should have a larger gap. As such, a more reasonable representation should be calculated based on the approach given in Ai and Vafai (2006).

To obtain more realistic values of w, Ai and Vafai (2006) presented a logical approach through the application of circuit analogy to obtain:

$$\frac{{N}^{″}}{c} = \frac{{D}_{end} P {e}_{end} exp ( P {e}_{end} )}{{H}_{end} ( exp ( P {e}_{end} ) - 1 )} \qquad Eq . ( 9 )$$

where N″ is solute mass flux per area, H_{end} thickness of endothelium, and the Peclet number for endothelium Pe_{end} can be expressed as:

$$P {e}_{end} = \frac{( 1 - {σ}_{end} ) {H}_{end}}{{D}_{end}} u \qquad Eq . ( 10 )$$

Further, in Ai and Vafai's (2008) work, the normal case corresponded to a lumen pressure of 100 mmHg, N″/c=2×10⁻¹⁰ [m/s], u=1.78×10⁻⁸ m/s, and K_{end}=3.22×10⁻²¹ [m²] (Truskey et al., 1992; Meyer et al., 1996; Huang and Tarbell's, 1997). Solving equations 6 to 10 results in the half width of the leaky junction as 14.343 nm, when the gage pressure is 70 mmHg. The properties of endothelium with gage pressure of 70 mmHg can be seen in Table 2, which is used as a reference value when calculating properties due to deformation.

### 1.5 Deformation-Pore Size (ε-w) Relation

The θ-direction strain ε, obtained from the elastic equation, is considered to have a substantially more impact on the pore size w due to the pore shape and distribution. To correlate ε with w, a coefficient βᵢⱼ is introduced as:

$${β}_{ij} = \frac{{ɛ}_{lj}}{ɛ} \qquad Eq . ( 11 )$$

where εᵢⱼ is the expansion ratio of the leaky junction. Since cross-sectional area of the leaky junction is 2πR_{cell}w, w can be considered as a function of ε:

$$w = {w}_{70 mmHg} \frac{1 + {β}_{lj} ɛ}{1 + {β}_{lj} {ɛ}_{70 mmHg}} \qquad Eq . ( 12 )$$

### 2. METHODOLOGY AND VALIDATION

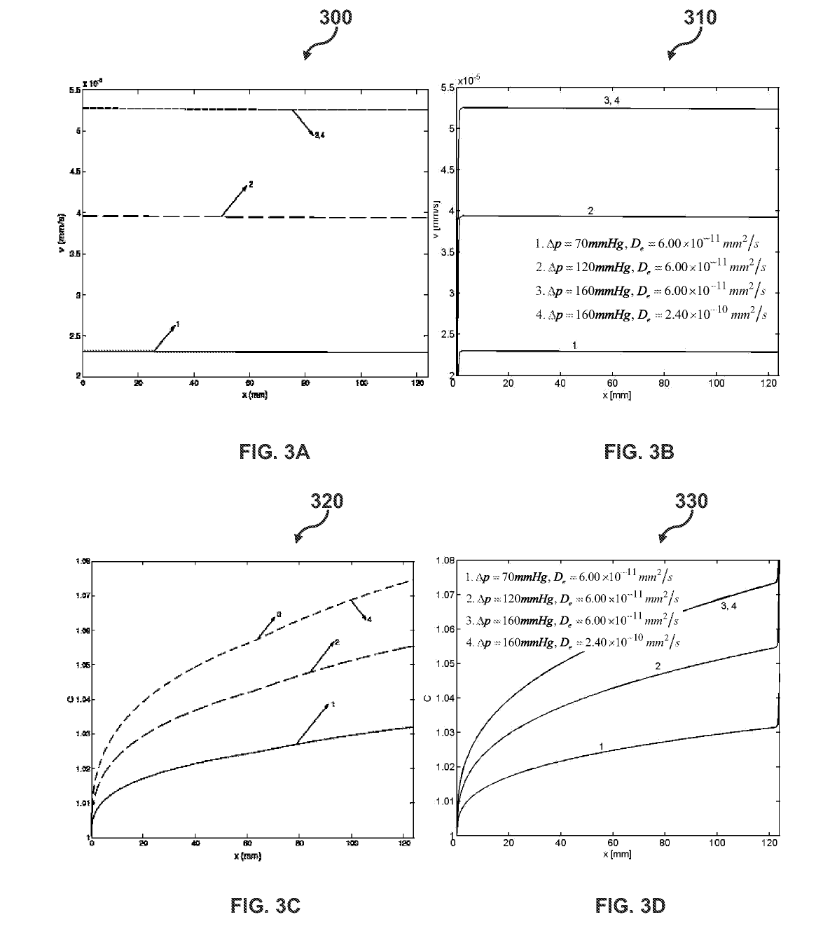

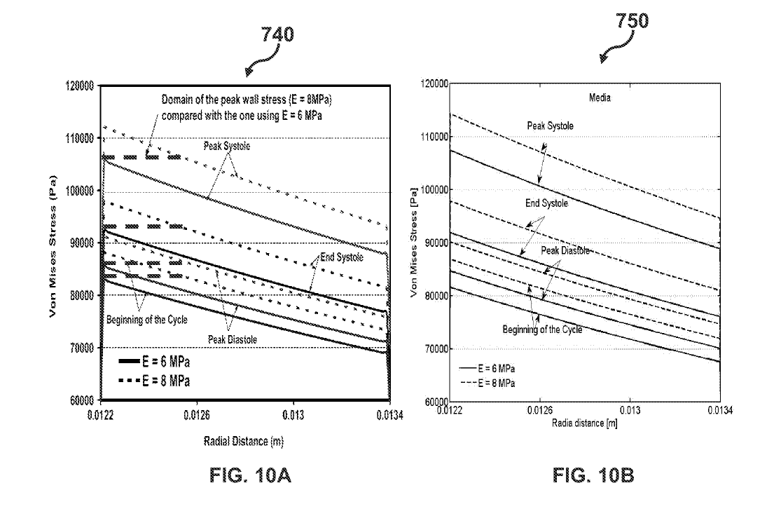

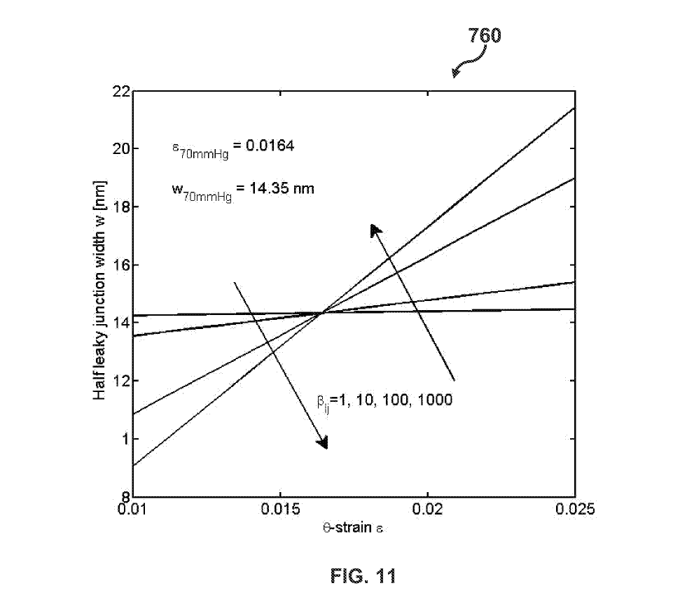

Comsol Multi-physics software is used to solve the governing partial differential equations in this work. A detailed systematic set of runs are executed to ensure that the results are grid and time step independent with relative and absolute error of 10⁻³ and 10⁻⁶, respectively. The disclosed embodiments and the computational results are validated through comparison with the available limiting cases in the literature. The LDL component was compared as depicted in FIGS. 3A-9B with the works of Yang and Vafai (2006, 2008) and Ai and Vafai (2008), while validation for FSI model as depicted in FIGS. 10A-11 was done with the work of Khanafer and Berguer (2009).

FIGS. 3A-3B illustrate graphs 300 and 310 showing comparison of filtration velocity of Yang and Vafai (2006) and the disclosed embodiments, respectively, and FIGS. 3C-3D illustrate graphs 320 and 330 showing comparison of LDL concentration at lumen-endothelium interface of Yang and Vafai (2006) and the disclosed embodiments, respectively.

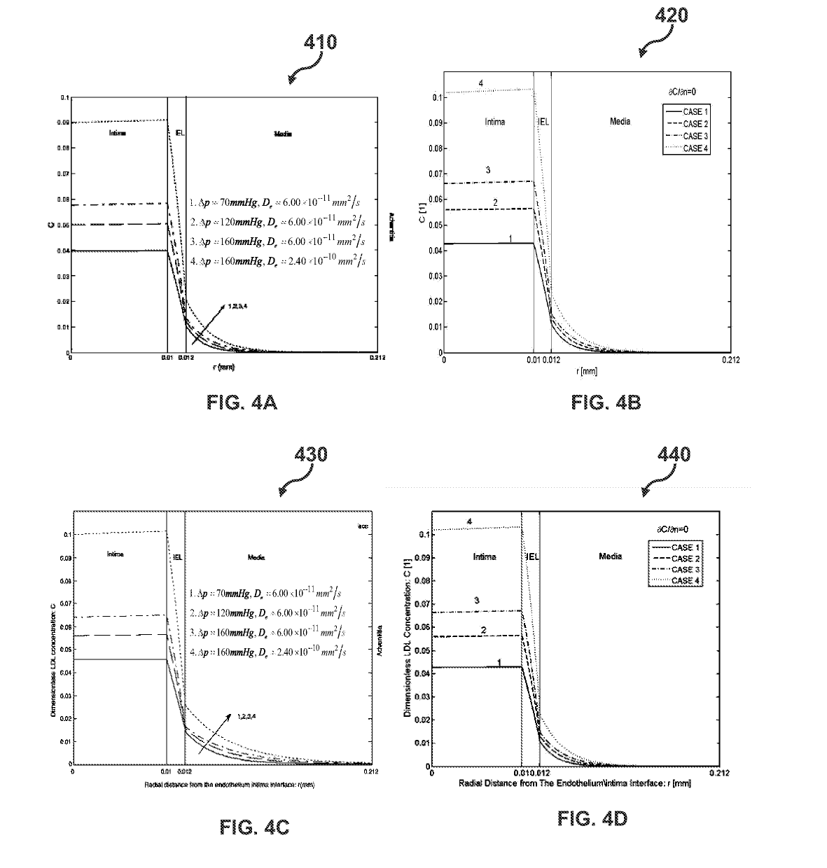

FIGS. 4A-4B illustrate graphs 410 and 420 showing comparison of normalized LDL concentration across intima, IEL, and media at different gage pressures and effective diffusivities with numerical results of Yang and Vafai (2006) and the disclosed embodiments, respectively, and FIGS. 4C-4D illustrate graphs 430 and 440 showing comparison of normalized LDL concentration across intima, IEL, and media at different gage pressures and effective diffusivities with analytical results of Yang and Vafai (2008) and the disclosed embodiments, respectively.

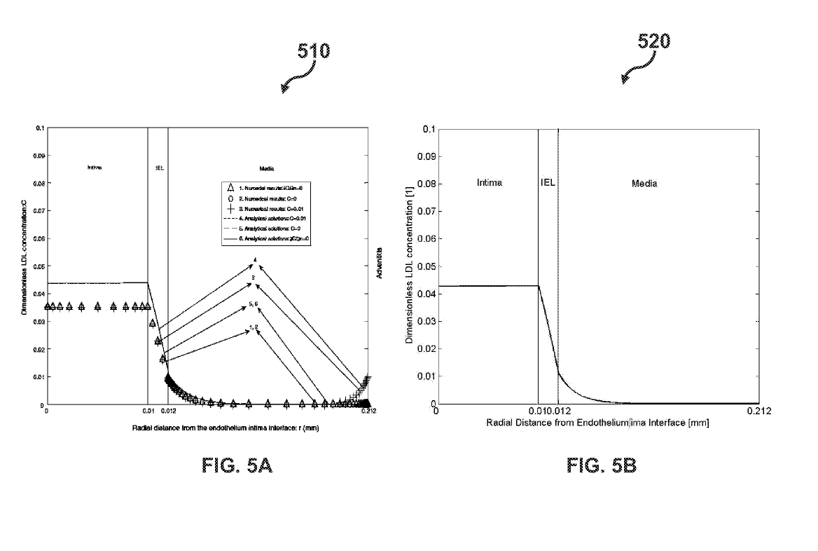

As can be seen in FIGS. 3A-4D, both the filtration velocity and LDL concentration are in very good agreement with Yang and Vafai's (2006) numerical results which are obtained using an entirely different solution scheme. Comparisons of LDL concentration across intima, IEL and media with both numerical and analytical results of Yang and Vafai (2006, 2008) are demonstrated in graphs 510 and 520 of FIGS. 5A-5B. Once again a very good agreement is observed with only a very small difference near endothelium-intima interface. The present results are very close to those of Yang and Vafai (2006, 2008), especially to Yang and Vafai's analytical work (2008).

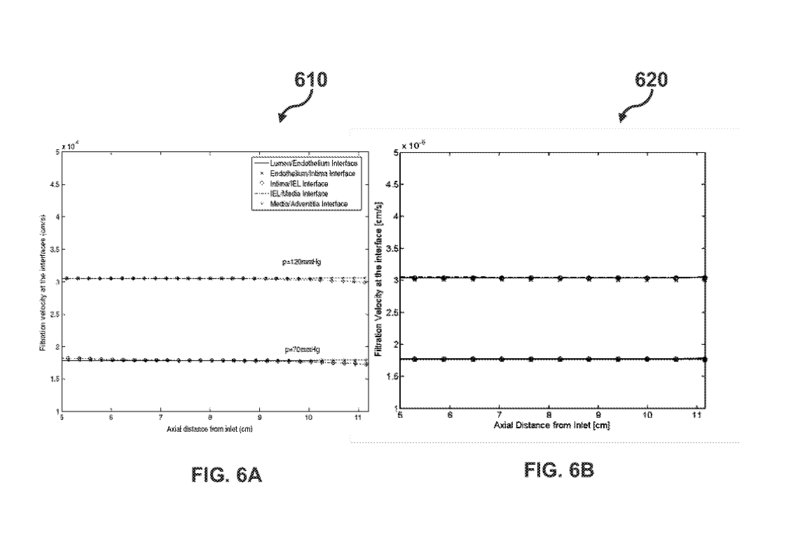

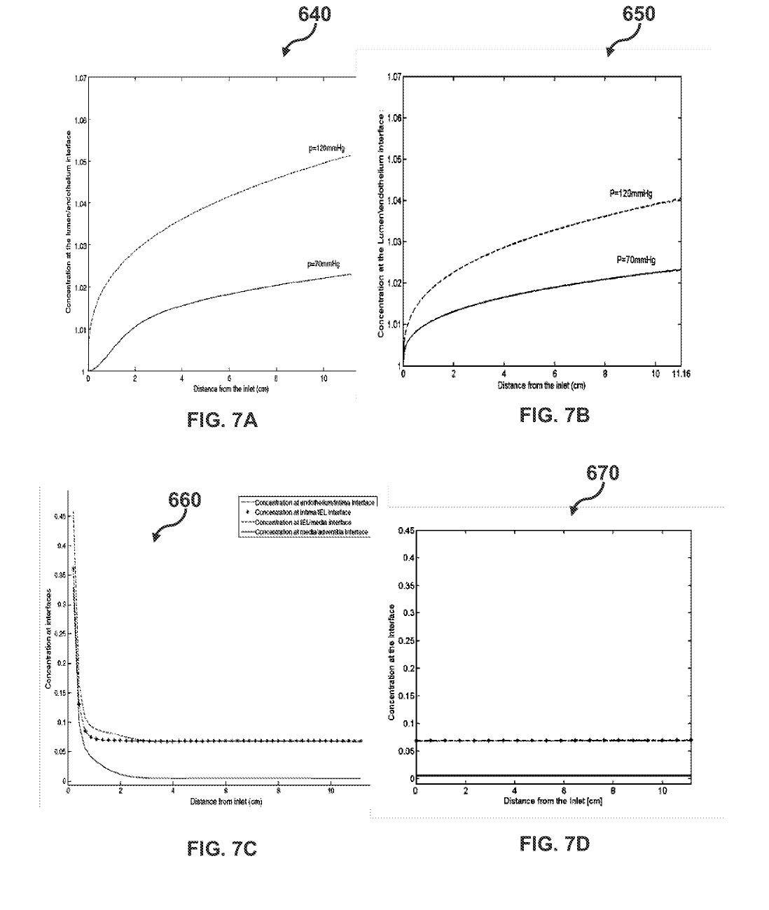

For further validation of computational results and LDL transport model within the multi-layers, another set of comparisons with Ai and Vafai's (2008) work are shown in FIGS. 6A-8D. FIGS. 6A-63 illustrate graphs 610 and 620 showing comparison of filtration velocity at different interface and axial locations of Ai and Vafai (2008) and the disclosed embodiments, respectively. FIGS. 7A-7B illustrate graphs 640 and 650 showing comparison of normalized LDL concentration at lumen-endothelium interface of Ai and Vafai (2008) and the disclosed embodiments, respectively, and FIGS. 7C-7D illustrate graphs 660 and 670 showing comparison of normalized LDL concentration at other interface of Ai and Vafai (2008) and the disclosed embodiments, respectively.

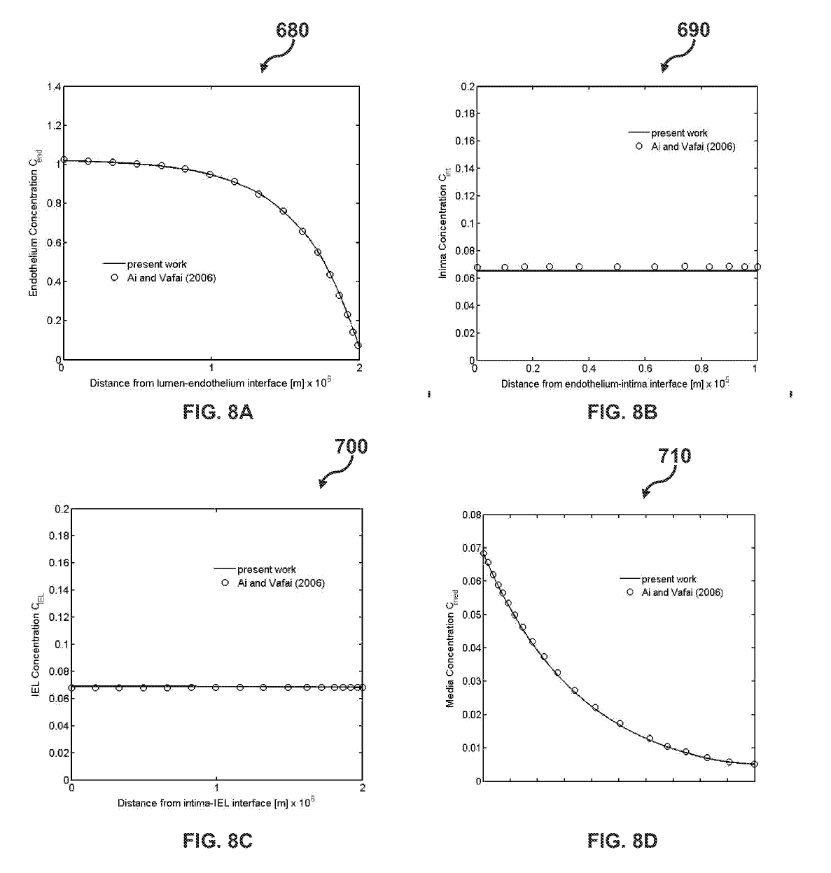

FIGS. 8A-8D illustrate graphs 680, 690, 700, and 710 showing comparison of normalized LDL concentration across endothelium, intima, IEI and media respectively of Ai and Vafai (2006) with the disclosed embodiments, in accordance with the disclosed embodiments. Filtration velocity and LDL concentration at endothelium-intima interface obtained in the present work are compared with those in an earlier study, resulting very good agreement as seen in FIGS. 6A-7D. A perfect agreement can be seen in FIG. 8A-8D for LDL concentration across each of the arterial layers against the results of Ai and Vafai (2008).

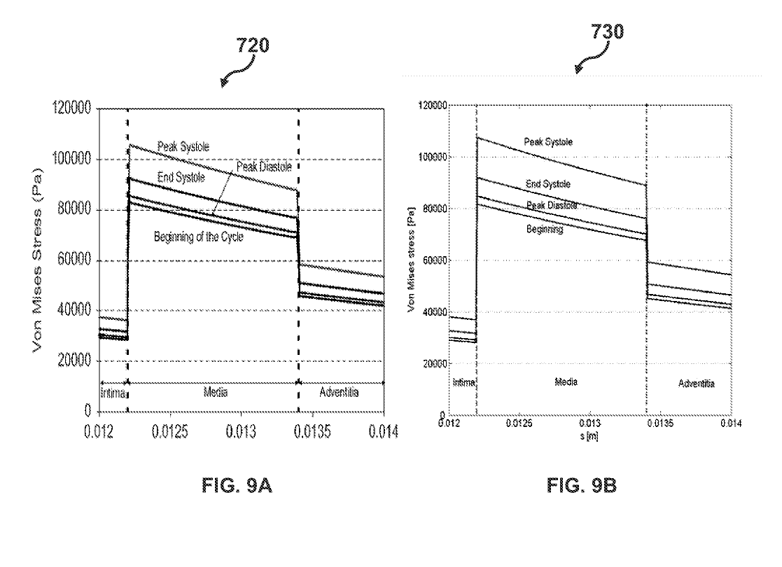

FIGS. 9A-9B illustrate graphs 720 and 730 showing comparison of Von Mises Stress across arterial wall at different steps in pulsation cycle of Khanafer and Ramon (2009) and the disclosed embodiments, respectively. FIGS. 10A-10B illustrate graphs 740 and 750 showing Von Mises Stress across media at different steps in pulsation cycle and different modulus of elasticity with those by Khanafer and Ramon (2009) and the disclosed embodiments. The disclosed results are compared with those obtained by Khanafer and Berguer (2009), showing excellent agreement for the results presented in FIGS. 9A-10B. FIGS. 3A-10B establish and validate different modules of the current models against available limiting cases in the literature covering both multilayer as well as the FSI attributes.

### 3. RESULTS AND DISCUSSION

### 3.1 FSI Effect

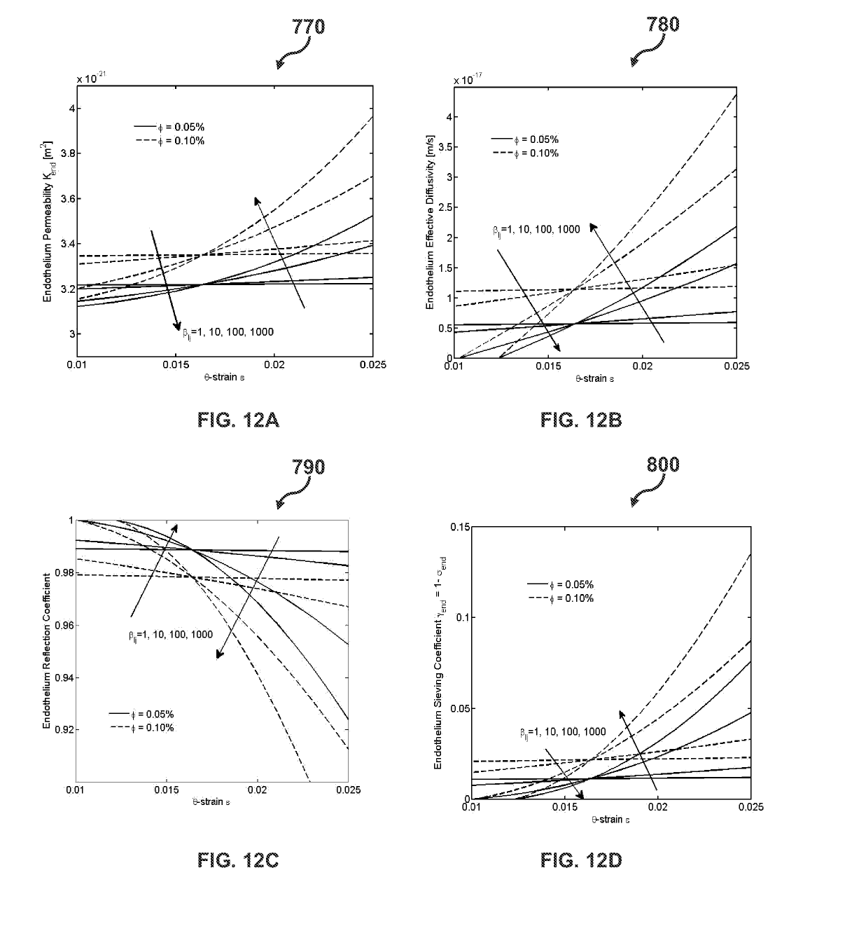

FIG. 11 illustrates a graph 760 showing the variations of the half width of the leaky junction w versus the angular strain ε. This representation is based on equation (12), which shows that w increases linearly with an increase in ε. Larger βᵢⱼ produces a more substantial deformation of the pore size at larger values of ε, while reaching a limiting case at a certain value of ε beyond which w decreases as βᵢⱼ increases. Using equations (6-11), the variations of pertinent properties such as endothelium's permeability, effective diffusivity, and reflection coefficient with ε are illustrated in FIGS. 12A-12D. The effective properties for a higher fraction of leaky junction φ=0.10% are also shown in FIGS. 12A-12D.

FIGS. 12A-12D illustrate graphs 770, 780, 790, and 800 showing permeability K_{end}, effective diffusivity D_{eff}, reflection coefficient σ_{end}, and sieving coefficient γ_{end}(=1−σ_{end}), variations with angular strain ε at different φ and βᵢⱼ of endothelium, respectively. With respect to flow penetration, the permeability of a leaky junction is more than that of a normal junction permeability, which experiences a negligible change with deformation. However, the fraction of leaky junctions is much smaller than normal junction. On the other hand, LDL will mainly pass across the endothelium layer through a leaky junction, rather than a normal junction whose cross-section area is too small for LDL transport.

Therefore, as can been seen in FIGS. 12A-12D, variations in ε have a more pronounced impact on the effective diffusivity and reflection coefficient as compared to the permeability. To further illustrate the deformation effect on the reflection coefficient, the variations of the sieving coefficient γ_{end}(=1−σ_{end}) with the θ-strain ε are displayed on FIGS. 12A-12D showing how convection is affected by deformation. FIGS. 12A-12D, confirms the physical expectations, that endothelium is more permeable for both blood flow and LDL molecule transport for larger deformations. Also, as can be seen in FIGS. 12A-12D, the endothelium becomes more permeable at a higher fraction of leaky junctions φ. This is due to the fact that a single leaky junction has a substantially larger cross-sectional area than a single normal junction has.

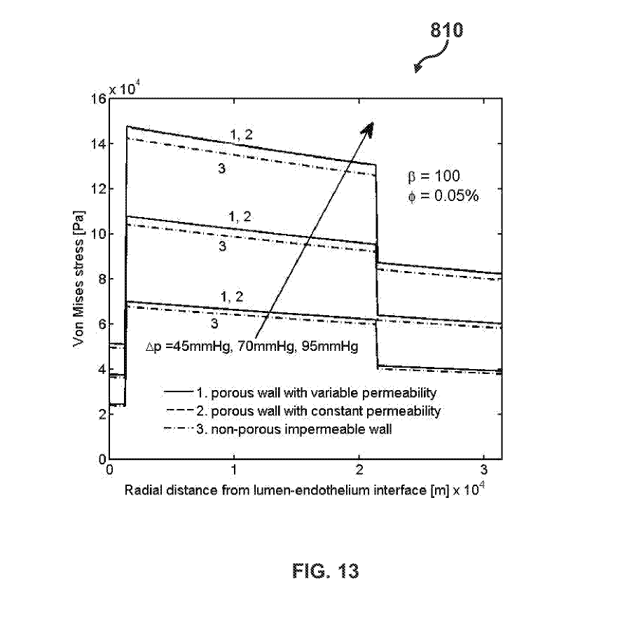

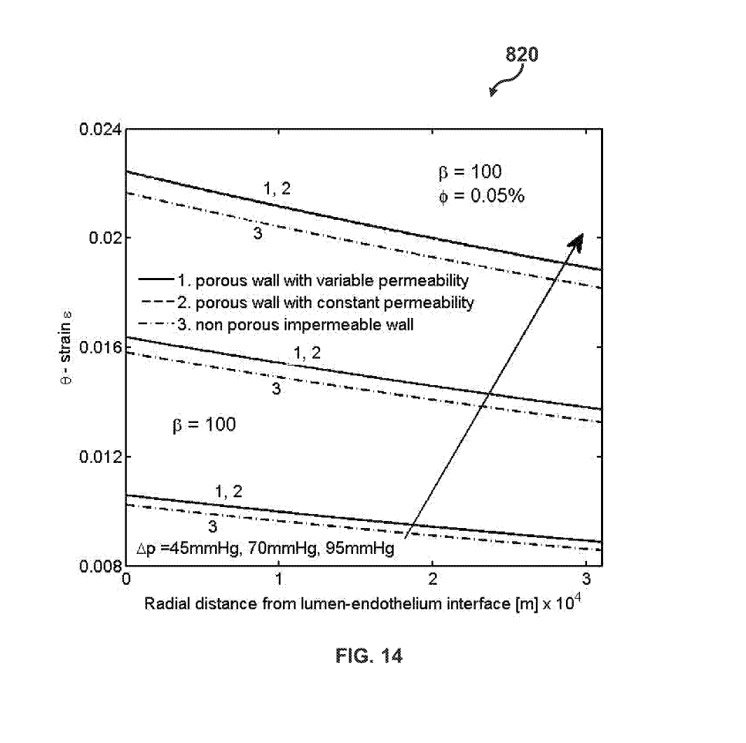

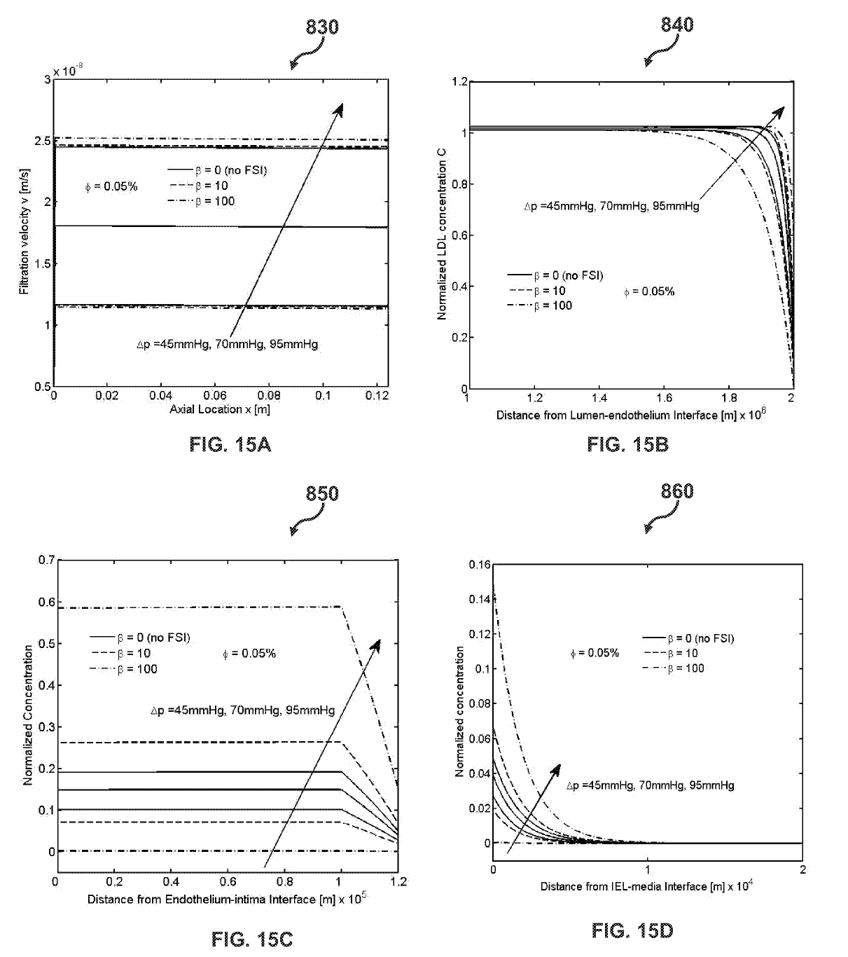

FIGS. 13 and 14 respectively illustrate graphs 810 and 820 depicting the angular strain and von Misses stress variations of the endothelium layer for different pressure drops across the lumen and the outer arterial wall respectively. It can be seen that consideration of porous wall has a significant impact on the FSI results. On the other hand, variable permeability caused by deformed pores has a minor influence on the elastic behavior of the arterial wall due to a small fraction of leaky junctions (φ=0.05%&0.10%). The filtration and concentration distributions within different layers, while accounting for FSI effects and variable permeability, diffusivity, and reflection coefficient at different pressure levels are shown in FIGS. 15A-15D. FIGS. 15A-15D illustrate graphs 830, 840, 850, and 860 showing filtration velocity variations at the lumen-endothelium interface and normalized LDL concentration across endothelium, intima and IEL, and media for different β and Δp, respectively.

The results of angular strain ε are then incorporated with those in FIGS. 12A-12D, resulting the flow penetration and LDL concentration distributions shown in FIGS. 15A-15D. Part a of FIGS. 15A-15D shows that the hydraulic pressure gradient dominates the flow penetration within different layers of an artery. FSI has a substantially more limited effect in enhancing the flow penetration in terms of creating a variable permeability and deformed leaky junction. This is because the deformation by FSI poses an insignificant effect due to the limited flow through the leaky junction (φ=0.05%&0.10%) as compared to that through the normal junction.

FIGS. 15A-15D also depicts the impact of endothelium deformation on LDL transport for different pressure drops across lumen and the outer arterial wall. Since leaky junction affects the diffusion of LDL macromolecules, FSI has a more pronounced affect on the concentration distribution across different layers as seen in FIGS. 15A-15D. This is in contrast to the relatively insignificant effect of FSI on the filtration velocity. FIGS. 15A-15D clearly shows that FSI augments the impact of pressure change across the arterial wall. As can be seen in FIGS. 15A-15D, the pressure and FSI effects are most significant within the intima layer. The impact of FSI becomes more pronounced as βᵢⱼ increases due to a larger cross-sectional area of a leaky junction.

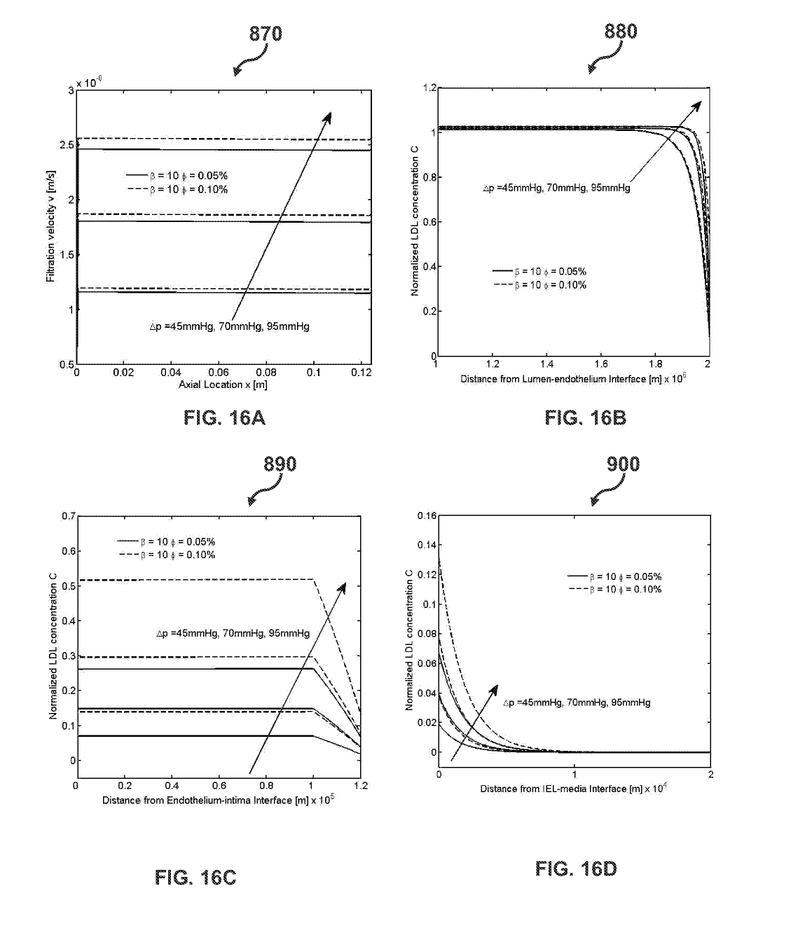

FIGS. 16A-16D illustrate graphs 870, 880, 890, and 900 showing filtration velocity variations at the lumen-endothelium interface and normalized LDL concentration across endothelium, intima and IEL, and media for different φ and Δp, respectively. As seen in FIGS. 16A-16D, when φ increases from 0.05% to 0.10%, the permeability for blood flow as well as LDL transport increases resulting in a higher value of filtration velocity and LDL concentration. Again, this is due to the fact that a leaky junction has a much larger cross-sectional area than a normal junction, which allows more blood flow and LDL molecules through the endothelium layer. As φ increases, the impact of FSI becomes more pronounced because the deformation of a leaky junction is significantly more than that of a normal junction.

### 3.2 Pulsation Effect

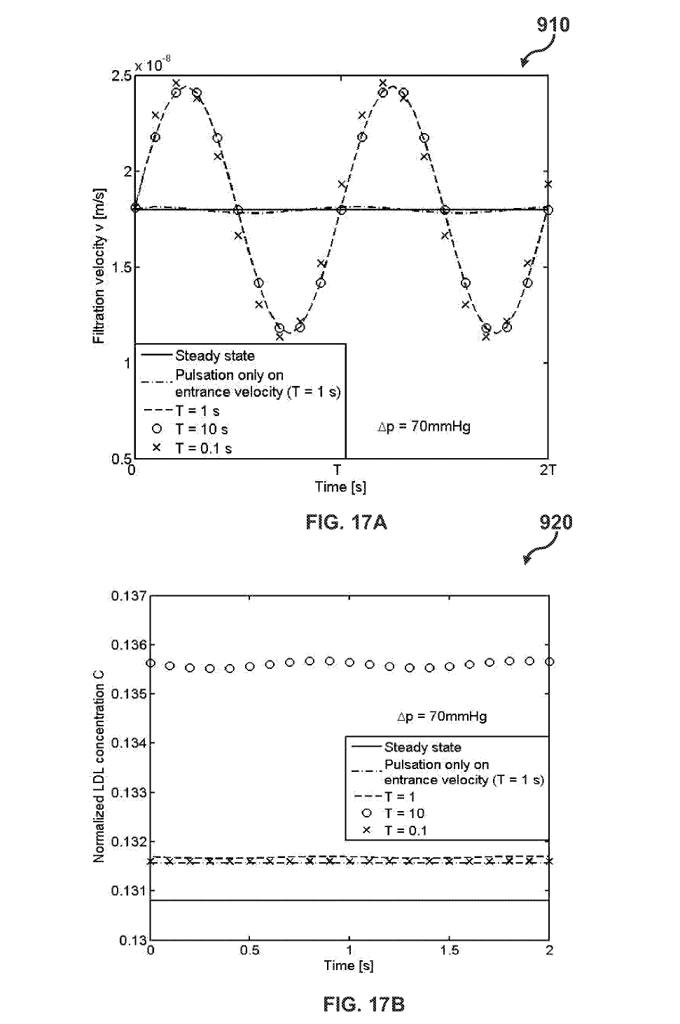

FIGS. 17A-17B illustrate graphs 910 and 920 showing filtration velocity variations at the lumen-endothelium interface and normalized LDL concentration across endothelium, intima and IEL, and media for different φ and Δp, respectively. FIGS. 17A-17B shows the impact of pulsation on the entrance velocity and pressure. As can be seen in FIGS. 17A-17B, the pulsation has a more pronounced effect on the concentration distribution for larger values of pulsation period T. Also, as can be seen in FIGS. 17A-17B, incorporating pulsation for the pressure increases the filtration velocity and concentration, while the velocity pulsation has an insignificant effect on the results. It should be noted that the impact of pulsation on LDL concentration is quite limited due to the very dominant transient effect on mass transfer caused by the very small pulsation period (T=1 s).

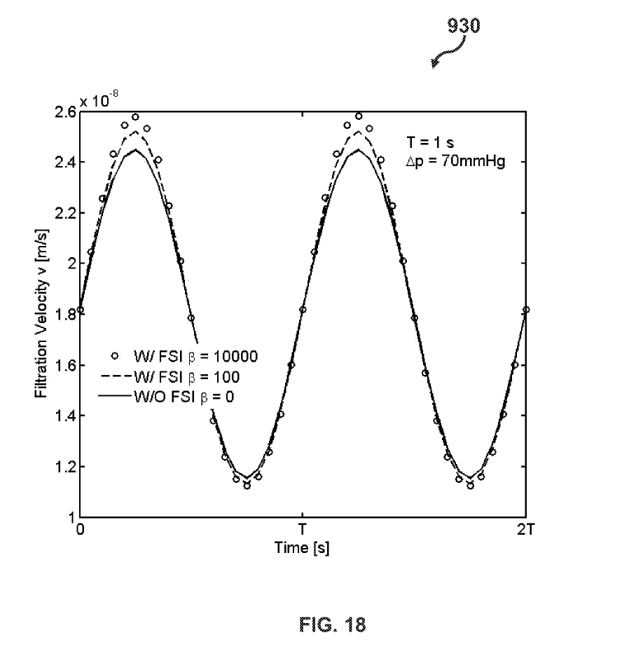

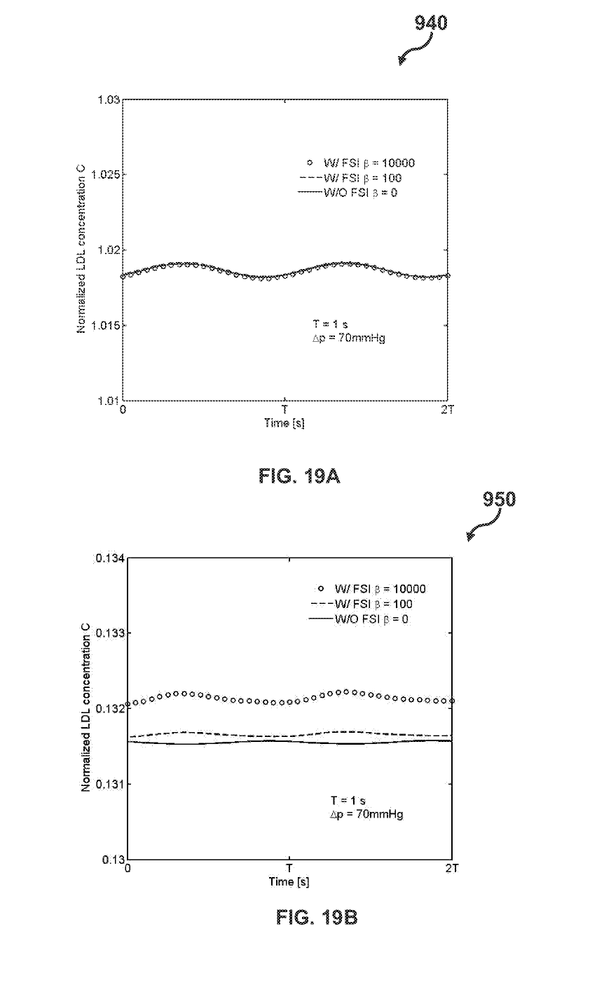

FIG. 18 illustrates a graph 930 showing the FSI effect on filtration velocity when pulsation is taken into account. As was the case for the steady state results (FIG. 15A), FSI does not have a significant effect on the results since the leaky junction plays a minor role on the flow penetration. FIGS. 19A-19B shows graphs 940 and 950 in that FSI has a negligible effect on the temporal concentration response in contrast to the FSI's significant effect on the steady state concentration distribution. The reason that FSI has a less pronounced effect on the concentration profile under pulsation is due to the substantial damping effect of the pulsatile flow in an artery.

### 4. CONCLUSIONS

A comprehensive model, which incorporates multi-layer features as well as Fluid Solid Interactions (FSI) for investigating LDL transport can be analyzed. The disclosed model and the computational results are in excellent agreement with prior results. The presented model incorporates coupling of LDL transport and FSI and accounts for the elastic deformation of endothelium. Pore theorem is utilized to relate pore structure with hydraulic and mass-transfer parameters. Under steady state conditions, there is a significant impact from FSI on LDL concentration but a minor effect on filtration velocity. When pulsation effects are taken into account, the impact of FSI is quite minor due to the time period for the blood pulsation.

It will be appreciated that variations of the above disclosed apparatus and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A method for analyzing the effects of Fluid Solid Interactions (FSI) and pulsation on the transport of Low-Density Lipoprotein (LDL) through an elastic wall, said method comprising:
utilizing a multi-layer model for LDL transport with FSI effects;
analyzing a change of hydraulic and mass transfer properties due to elastic wall deformation associated with at least one elastic wall;
analyzing said FSI effects on flow and said LDL transport through said at least one elastic wall; and
analyzing an impact of pulsatile flow and/or hypertension in association with said FSI effects on said LDL transport within said at least one elastic wall.

2. The method of claim 1 further comprising generating data indicative of a significant impact from said FSI effects on LDL concentration data indicative of a minor effect on filtration velocity under steady state conditions.

3. The method of claim 1 further comprising generating data indicative of a minor impact of said FSI effects due to a time period for blood pulsation and taking into account pulsation effects and/or said hypertension.

4. The method of claim 1 further comprising analyzing an impact of said pulsatile flow and/or said hypertension within an artery with and without said FSI effects.

5. The method of claim 1 further comprising employing a pore theorem to relate pore structure with hydraulic and mass-transfer parameters.

6. The method of claim 1 further comprising analyzing and comparing said multi-layer model with existing results in limiting cases.

7. The method of claim 1 wherein said multi-layer model takes into account complete multi-layered LDL transport while incorporating said FSI effects to enable a comprehensive study of a deformation effect on pertinent parameters of transport processes within an artery.

8. The method of claim 1 wherein said at least one elastic wall comprises at least one arterial wall.

9. The method of claim 1 further comprising:
generating data indicative of a minor impact of said FSI effects due to a time period for blood pulsation and taking into account pulsation effects and/or said hypertension; and
analyzing an impact of said pulsatile flow and/or said hypertension within an artery with and without said FSI effects.

10. The method of claim 9 wherein said multi-layer model takes into account complete multi-layered LDL transport while incorporating said FSI effects to enable a comprehensive study of a deformation effect on pertinent parameters of transport processes within an artery.

11. The method of claim 9 wherein said at least one elastic wall comprises at least one arterial wall.

12. The method of claim 10 further comprising employing a pore theorem to relate pore structure with hydraulic and mass-transfer parameters.

13. The method of claim 10 further comprising analyzing and comparing said multi-layer model with existing results in limiting cases.
